(19) United States
(12) Patent Application Publication
(10) Pub. No.: US 2016/0273908 A1
(43) Pub. Date: Sep. 22, 2016

(54) PREVENTION OF LIGHT FROM EXTERIOR TO A DEVICE HAVING A CAMERA FROM BEING USED TO GENERATE AN IMAGE USING THE CAMERA BASED ON THE DISTANCE OF A USER TO THE DEVICE

(71) Applicant: Lenovo (Singapore) Pte. Ltd., New Tech Park (SG)

(72) Inventors: Amy Leigh Rose, Chapel Hill, NC (US); Nathan J. Peterson, Durham, NC (US); John Scott Crowe, Durham, NC (US); Bryan Loyd Young, Tualatin, OR (US)

(21) Appl. No.: 14/659,803

(22) Filed: Mar. 17, 2015

(51) Int. Cl. G01B 11/14; H04N 5/232; H04N 13/02

(52) U.S. Cl. CPC G01B 11/14; H04N 13/0207; H04N 5/23216

(57) ABSTRACT

In one aspect, a device includes a processor, a camera accessible to the processor, and memory accessible to the processor. The memory bears instructions executable by the processor to determine that a user is at least one of outside a threshold distance from the device and at a threshold distance from the device, and responsive to the determination, disallow the camera from generating images based on light from exterior to the device.

### FIELD

The present application relates generally to prevention of light from exterior to a device having a camera from being used to generate an image using the camera based on a distance of a user to the device.

### BACKGROUND

Cameras on devices such e.g. smart phones and laptops can be enabled remotely and often secretly by unauthorized individuals, and such an unauthorized individual may thus invade the privacy of a user of the device by viewing images gathered by the remotely enabled camera. Often times, these devices include a light disposed next to the camera which illuminates when the camera is on but this light can also be disabled remotely by the unauthorized individual. Thus, should the camera be enabled remotely by the unauthorized individual and the light disabled from illuminating, the user of the device may not know that some one is using their camera to gather images of the device's surroundings and invade the user's privacy. Camera covers are also sometimes included on these devices, but if the user forgets to shield the camera with the cover when the camera is not in use, the unauthorized individual may still view images gathered by the camera without the use's permission and/or knowledge.

### SUMMARY

Accordingly, in one aspect a device includes a processor, a camera accessible to the processor, and memory accessible to the processor. The memory bears instructions executable by the processor to determine that a user is at least one of outside a threshold distance from the device and at a threshold distance from the device, and responsive to the determination, disallow the camera from generating images based on light from exterior to the device.

In another aspect, a method includes determining that no person is proximate to a device, and at least in response to determining that no person is proximate to the device, operating the device to limit light from passing from outside the device through a lens of a camera on the device.

In yet another aspect, a computer readable storage medial that is not a transitory signal comprises instructions executable by a processor to, in response to a determination that a person is not within a threshold distance of a device, prevent a camera on the device from generating images based on light from exterior to the device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles;

FIGS. 4 and 5 are example block diagrams of a tablet computer in accordance with present principles;

FIGS. 6 and 7 are example cross-sectional views of a device including a camera in accordance with present principles:

FIG. 8 shows an example user interface (UI) in accordance with present principles; and

FIG. 9 is an example illustration in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or an combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

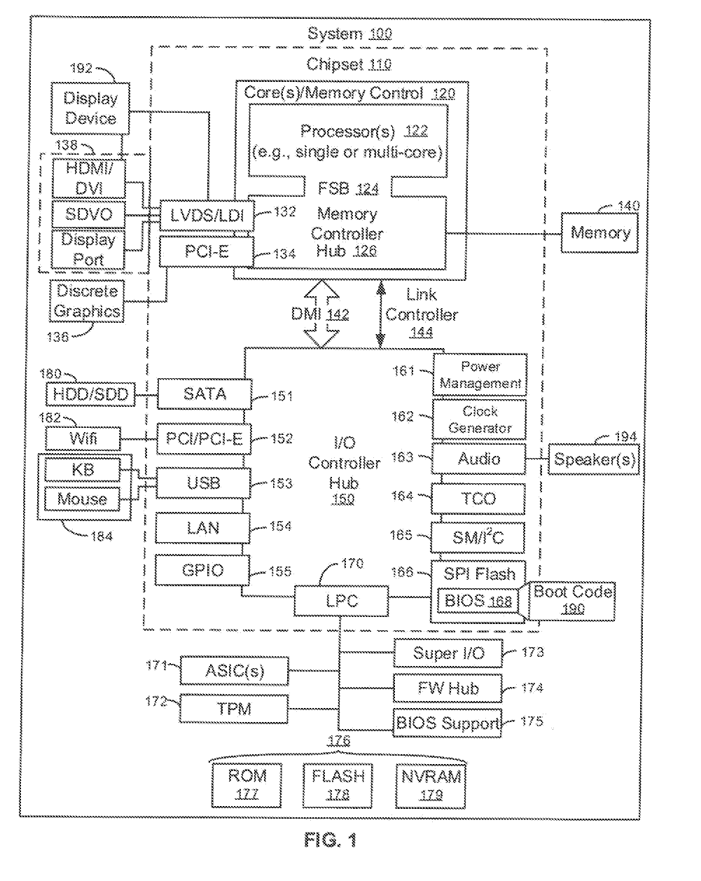

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller nub 126 also includes one or more PCI-express interfaces (PCI-E) 134, for example, for support of discrete graphics 136. Discrete graphics using as PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the 110 hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122 an audio receiver/microphone providing input to the processor 122 e.g. based on a user providing audible input to the microphone, and a camera for gathering one or more images and providing input related thereto to the processor 122. The camera may be, e.g., a three dimensional (3D) camera, a thermal imaging camera, a digital camera such as a webcam, and/or a camera integrated into the system 100 and controllable by the processor 122 to gather pictures/images and/or video. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles e.g. determine the location of the system 100.

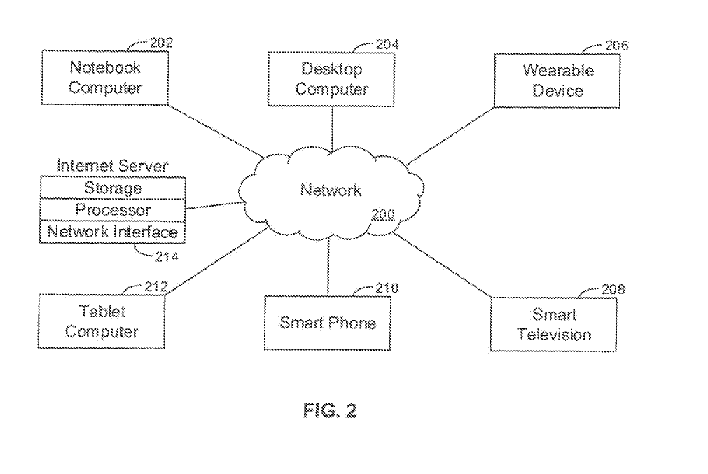

Before moving on to FIG. 2, it is to be understood that an example client device or other machine/computer may include fewer or more features than shown on the system 100 of FIG. 1. In any case, it is to be understood at least based on the, foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

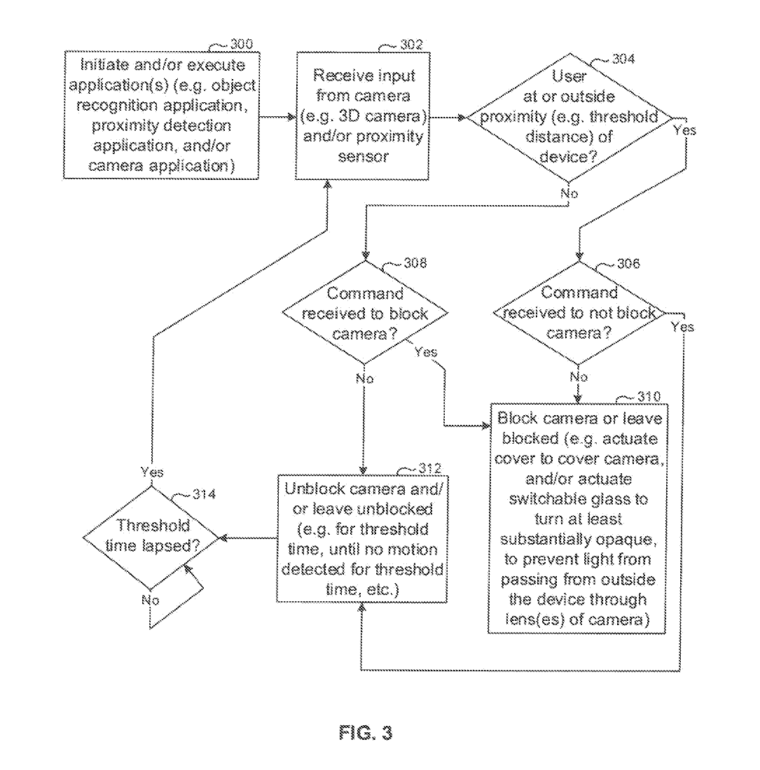

Referring to FIG. 3, it shows example logic that may be undertaken by a device such as the system 100 in accordance with present principles. Beginning at block 300, the logic initiates and/or executes one or more applications for undertaking present principles, such as e.g. an object recognition application for recognizing objects such as people and animals based on images from a camera, a proximity detection application for determining the proximity of objects to the device undertaking the logic of FIG. 3 (referred to below as the “present device”) using input from one or more proximity sensors, a camera application for gathering pictures and video using a camera, and/or a single application integrating one or more of the foregoing applications and/or software. In any case, from block 300 the logic proceeds to block 302, where the logic receives input from a camera (e.g. a 3D camera) e.g. on the present device, and/or a proximity sensor on the present device.

From block 302 the logic moves to decision diamond 304. At diamond 304 the logic determines, based at least in part on the input received at block 302, whether at least one person (e.g. a user of the device) is at or outside a proximity to the present device, such as e.g. being outside a threshold distance to the present device and/or outside a distance at which an object such as a person is identifiable by the present device using images from the camera. Conversely, it is to be understood that in example embodiments, being proximate to the threshold device may include e.g. being at the present device (e.g. the present device being held in the user's hand), being within the threshold distance to the present device, and/or being within a distance at which an object such as a person is identifiable, by the present device using images from the camera. In any case, also note that the logic may make the determination at diamond 304 e.g. using object recognition software and/or proximity detection software in accordance with present principles.

An affirmative determination at diamond 304 causes the logic to proceed to decision diamond 306, while a negative determination at diamond 304 causes the logic to proceed to decision diamond 308. First discussing decision diamond 306, the logic determines thereat whether a command (e.g. from the user or another person) has been received to not block the camera (e.g. not block from collecting light from outside the camera to generate an image) as described herein and/or refrain from blocking the camera as described herein. An affirmative determination causes the logic to proceed to block 312, which will be described shortly. However, a negative determination instead causes the logic to move to block 310. At block 310 the logic blocks the camera or leaves it blocked (e.g. if it has already been blocked prior to making the determination at diamond 306). The camera may be blocked by e.g. actuating a cover on the present device to cover (e.g. an exposed surface of) the camera to thus prevent light from passing from outside the camera through a lens of the camera and/or otherwise preventing light from outside the camera from reaching the camera's imager, and/or covering the lens itself so that light may not pass therethrough from outside the present device and/or otherwise pass from outside the camera from reaching the camera's imager. The camera may also be blocked by e.g. actuating switchable material (e.g. glass, plastic, etc.) disposed e.g. between the camera and an exposed surface of the device to turn at least substantially opaque to thus prevent light from passing from outside the camera through the lens of the camera and/or otherwise reaching the camera's imager. At least substantially opaque may include opaque, and/or at least opaque enough so as to not allow light to pass therethrough that is at least in the spectrum gatherable by the camera to produce an image. Before moving on in the description of FIG. 3, note that although not shown, from block 310 the logic may end or alternatively revert back to block 302 and proceed therefrom.

Moving on now in the description of FIG. 3, as mentioned above, a negative determination at diamond 304 causes the logic to proceed to decision diamond 308. At diamond 308 the logic determines whether a command (e.g. from the user or another person) has been received to block the camera. An affirmative determination at diamond 308 causes the logic to proceed to block 310 and undertake the action(s) described above. However, note that a negative determination at diamond 308 instead causes the logic to move to block 312.

At block 312 the logic unblocks the camera (e.g. actuates the cover to uncover the camera, and/or actuates the switchable glass to turn at least substantially transparent (e.g. transparent, and/or transparent enough so as to allow light to pass therethrough that is at least in the spectrum gatherable by the camera to produce an image)), and/or leaves the camera unblocked if already unblocked. The camera may then be left unblocked at block 312 e.g. until a user command is received to block it again, until a user command is received to continue making the determination at diamond 304 and execute functions as described above accordingly, for a threshold time established by a user, and/or a threshold time during which no motion is detected (e.g. and for all time during which motion is detected).

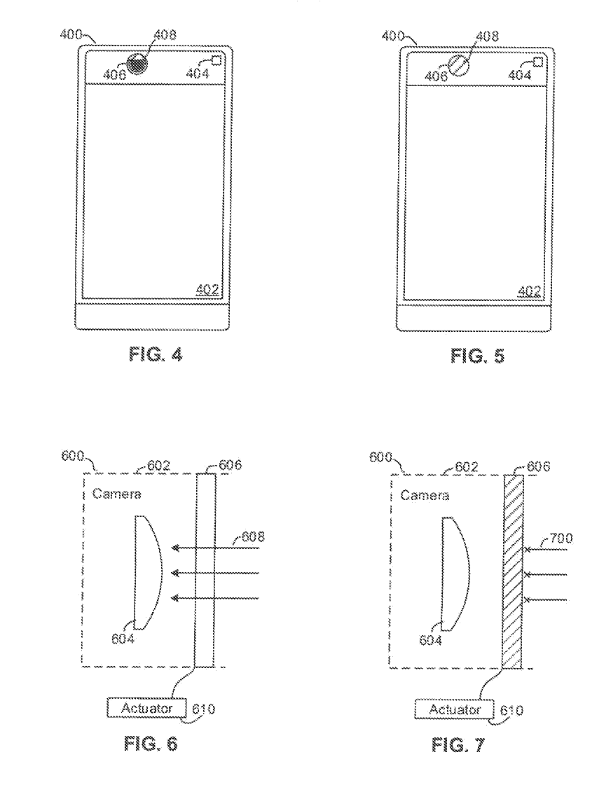

After block 312, the logic may, in some embodiments, proceed to decision diamond 314 should at least one of the above-described threshold times be tracked by the present device (e.g. if a user configured the present device to do so). At diamond 314 the logic determines whether one or more of those threshold times has lapsed. A negative determination at diamond 314 causes the logic to continue making the determination thereat, while an affirmative determination causes the logic to revert back to block 302 and proceed therefrom. Before moving on to the description of FIGS. 4 and 5, also note that in embodiments when at least one of the above-described threshold times is not being tracked by the present device, the logic may end thereat, or proceed from block 312 directly to block 302 and proceed therefrom.

Continuing the detailed description in cross-reference to FIGS. 4 and 5, they are block diagrams which show an example device 400 that may include some or all of the components described above with respect to the system 100 of FIG. 1. The device 400 in the present instance is understood to be a tablet computer. In any case, the device 400 comprises a display 402 on which images are presentable. The device 400 also includes at least one proximity sensor 404 for sensing the proximity of objects such as people. The proximity sensor(s) 404 may include e.g. a sonar proximity sensor, an ultrasonic proximity sensor, a radar proximity sensor, an infrared (IR) proximity sensor, a laser rangefinder, and/or an optical proximity sensor.

FIGS. 4 and 5 also show a camera 406 comprising a (e.g. mechanically and/or electrically operated) camera cover 408. When the cover 408 is positioned (e.g. by a user and/or based on commands from a processor of the device 400) in an at least partially open position as shown in FIG. 4, it does not obstruct light from passing from exterior to the device 400 through a lens (not shown for clarity) of the camera 406. However, when the cover 408 is positioned in a closed position as shown in FIG. 5, the cover 408 blocks light from passing from exterior to the device 400 through the lens. It is to thus be understood that in some example embodiments, the cover 408 covers an entire exposed surface of the device 400 through which light travels from exterior to the device 400 to the lens.

Now in cross-reference to FIGS. 6 and 7, they show example cross-sectional views of a device 600 including a camera 602, with portions cut away for clarity. The camera is understood to include at least one lens 604 used for producing an image. The camera is juxtaposed next to and/or abutting an exterior surface 606 of the device 600 which in at least some configurations is at least partially transparent so that light (represented by arrows 608) may travel from outside the device and through the lens 604 so that the camera 602 may generate at least one image.

Describing the surface 606 in more detail, it may be and/or incorporate e.g. a polarizer and/or switchable glass that may be mechanically and/or electrically operated by an actuator 610 under control of a processor of the device 600 (and/or by a user) for transitioning the surface between a transparent state in which light may pass therethrough to the lens 604 as shown in FIG. 4, and an opaque state as shown FIG. 5 (represented by the shading of the surface 606) in which light is not permitted to pass therethrough to the lens 604. Arrows and “X” marks 700 are thus shown in FIG. 7 to represent that light is blocked from passing through the surface 606 when in an at least substantially opaque state (e.g. totally opaque, and/or at least opaque enough so as to not allow light to pass that is at least in the spectrum useable by the camera 602 to generate an image). In example embodiments, the polarizer and/or switchable glass may be e.g. polarizing glass, a polarizing filter, a polarizing film, and still other kinds of so-called “smart glass.”

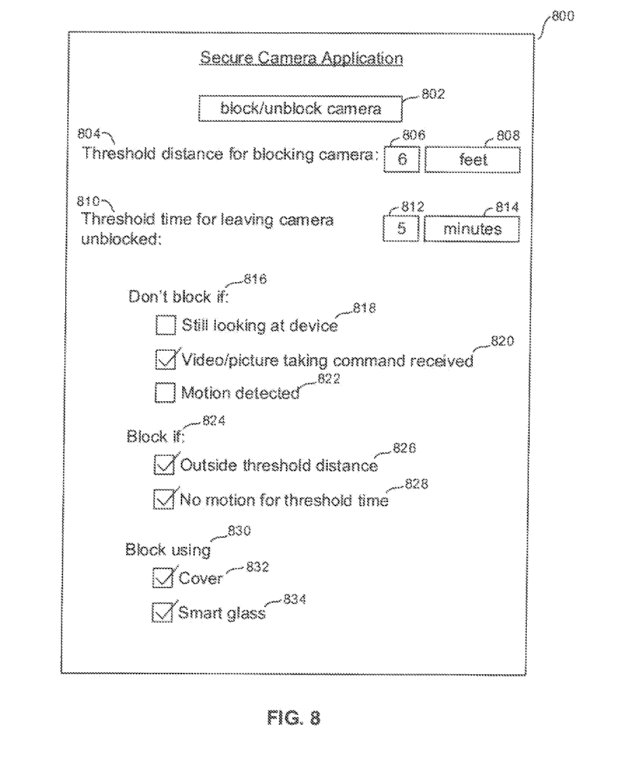

Continuing the detailed description in reference to FIG. 8, it shows an example user interface (UI) 800 presentable on a display of a device. The UI 800 is understood to pertain to configuring settings of a device and/or application(s) undertaking present principles. The UI 800 includes a selector element 802 which is selectable to automatically without further user input transition the device from a blocked camera state to an unblocked camera state and vice versa, as described herein, depending on whether the camera is currently blocked or unblocked respectively. Thus, the selector element 802 may be selected by a user (e.g. using touch input to a display on which the UI 800 is presented) to provide is command to actuate e.g. a cover and/or switchable glass as described herein.

The UI 800 also includes a setting 804 for a user to establish a threshold distance at which a user, when e.g. at or outside of it, will be identified as being outside of a proximity to the device which in turn may cause the device to disallow light from passing from exterior to the device through a lens of a camera of the device in accordance with present principles. Accordingly, the setting 804 includes a number entry box 806 at which a user may enter and/or select a number for establishing the threshold distance, and an increment selector box 808 at which a user may enter and/or select a distance increment to be associated with the number, such as e.g. centimeters, inches, feet, yards, meters, etc. As may be appreciated from FIG. 8, in the present instance the threshold distance has been set at six feet.

The UI 800 also includes a setting 810 for establishing a threshold time, if one is desired, at which a camera is left unblocked after being unblocked e.g. by the processor of the device and/or a user. After expiration such a threshold time, the device may automatically without further user input block the camera, such as e.g. by actuating a cover and/or switchable glass as described herein. In any case, the setting 810 includes a number entry box 812 at which a user may enter and/or select a number for establishing the threshold time, and an increment selector box 814 at which a user may enter and/or select a time increment to be associated with the number, such as e.g. seconds, minutes, hours, etc. As may be appreciated from FIG. 8, in the present instance the threshold time has been set at five minutes.

Still in reference to FIG. 8, it also shows a setting 816 at which a user may select one or more options (e.g. by selecting a corresponding check box as shown) to configure the device to not automatically block the camera in certain situations. The options may include e.g. an option 818 to not block the camera if the device identifies (e.g. using images from the camera and eye tracking software) the user as looking at the device even from beyond the threshold distance discussed above, an option 820 to not block the camera if the device has been commanded to use the camera to gather an image and/or video even if from beyond the threshold distance, and/or an option 822 to not block the camera if the device (e.g. using images from the camera and/or motion detection software) detects motion even if the motion is at a location beyond the threshold distance. Thus, as an example, if the user selected at least option 820 as shown in FIG. 8 and then commanded the camera to take a picture after a predetermined time delay, the user may then go and stand in front of the camera but beyond the threshold distance to take a picture of himself or herself without the camera being blocked by the device.

The UI 800 may also include a setting 824 at which a user may select one or more options (e.g. by selecting a corresponding check box as shown) to configure the device to automatically block the camera in certain situations. The options may include e.g. an option 826 to block the camera (e.g. regardless of other settings configured using the UI 800) when a person is identified as being outside the threshold distance, and an option 828 to block the camera if no motion is detected by the device for at least a threshold time, such as the threshold time described above. Note that in the present instance, both of options 826 and 828 have been selected based on selection of their corresponding check boxes as shown.

Last, note that the UI 800 includes a setting 830 at which a user may select one or more options (e.g. by selecting a corresponding check box as shown) to configure the device to automatically block the camera using a cover (e.g. option 832), and/or using a switchable glass and/or smart glass (e.g. option 834). Thus, it is to be understood that some devices in accordance with present principles may have both a cover and switchable glass which may be used by the device for undertaking present principles. Note that in the present instance, both of options 832 and 834 have been selected based on selection of their corresponding check boxes as shown.

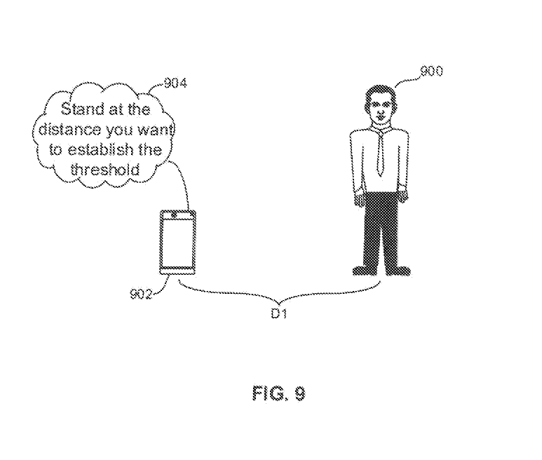

Now describing FIG. 9, it shows an example illustration in accordance with present principles in which a threshold distance as described herein may be established based on user input comprising a user 900 standing at a distance (e.g. represented on FIG. 9 as distance one) from a device 902 (e.g. similar to the device 400 described above), where distance one is the distance the user desires to be the threshold distance. Before moving on in the description of FIG. 9, it is to be understood that although not shown in FIG. 8, the UI 800 may include a selector element selectable to automatically without further user input prompt (e.g. on a display of the device and/or audibly using a speaker of the device) the user to stand at a distance the user desires to be the threshold distance. The device may then identify a current position of the user as input to establish the threshold distance, and then automatically determine the threshold distance based on the distance from the device to the user (e.g. once the user is standing at the desired location for a threshold time), and configure itself accordingly.

Regardless, as may be appreciated from the illustration of FIG. 9, an example audible prompt is represented by cloud quote 904. Thus, it is to be understood that the audible prompt may be automatically provided responsive to selection of a selector element on the 800 as described in the paragraph above. The audible prompt, in the present example, prompts the user to “Stand at the distance you want establish as the threshold.”

In accordance with present principles, it is to be understood that in addition to or in lieu of the foregoing, the cameras disclosed herein may be electronically disabled (for example, using software commands) when the user is outside of a threshold distance. For example, the camera's ability to transmit output signals to a processor in communication with the camera may be disabled and then re-enabled once the user provides appropriate authentication credentials and/or authorization for the camera to again provide output signals to the processor.

Furthermore, when a camera is either or both of disabled as disclosed in the paragraph immediately above and/or otherwise blocked as disclosed herein, the camera may be re-enabled and/or unblocked in response to an affirmative and/or predetermined user action at the device itself which comprises the camera, such as the user lifting a cover which was physically blocking the camera, the user providing a command for switchable glass to turn from opaque to transparent, the user selecting a selector element from a UI presented on a display of the device or otherwise providing a command to a software application controlling the camera to re-enable the camera, the user physically contacting a touch-based sensor on the device comprising the camera and/or a peripheral device (such as a mouse, stylus, and/or keyboard) where input related thereto is communicated to the device comprising the camera, the user moving the device comprising the camera and/or the peripheral device which is sensed by a motion sensor on the device being moved and where input related thereto is communicated to the processor of the device comprising the camera etc.

It may now be appreciated that present principles provide for e.g. automatically physically blocking a camera of a device (e.g. mobile device and/or laptop) if a user moves a certain configurable distance away from the device. The user may be able to verify the camera is blocked by simply looking at it to see that it is physically blocked by a mechanical cover that can be automatically deployed if the user walks away from the device, and/or by polarized glass that can be operated to turn opaque when the user walks away from the device. Further, in some embodiments the user may manually disable the automatic camera blocking if the user wanted to take a video of something relatively further away from the screen beyond the configurable distance.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a transitory signal and/or a signal per se.

While the particular PREVENTION OF LIGHT FROM EXTERIOR TO A DEVICE HAVING A CAMERA FROM BEING USED TO GENERATE AN IMAGE USING THE CAMERA BASED ON THE DISTANCE OF A USER TO THE DEVICE is herein shown and described in detail, it is to be understood that the subject matter which is encompassed by the present application is limited only by the claims.

What is claimed is:

1. A device, comprising:
a processor;
a camera accessible to the processor; and
memory accessible to the processor and bearing instructions executable by the processor to:
determine that a user is at least one of outside a threshold distance from the device and at a threshold distance from the device; and
responsive to the determination, disallow the camera from generating images based on light from exterior to the device.

2. The device of claim 1, wherein the instructions are executable to:
responsive to the determination, disallow light from passing from exterior to the device to the camera.

3. The device of claim 2, comprising a cover, wherein light is disallowed from passing from exterior to the device to the camera at least in part based on actuation of the cover to cover at least one of a lens of the camera and an exterior surface of the camera through which light passes to the lens.

4. The device of claim 2, wherein a portion of the device through which light travels from exterior to the device to the camera comprises at least one polarizer, and wherein light is disallowed from passing from exterior to the device to the camera at least in part based on actuation of the at least one polarizer to render the portion at least substantially opaque.

5. The device of claim 2, wherein a portion of the device through which light travels from exterior to the device to the camera comprises electrically-switchable material, and wherein light is disallowed from passing from exterior to the device to the camera at least in part based on actuation of the electrically-switchable material to render the electrically-switchable material at least substantially opaque.

6. The device of claim 1, comprising a display accessible to the processor, wherein the threshold distance is configurable at least in part based on receipt of user input to a user interface (UI) presentable on the display.

7. The device of claim 1, wherein the threshold distance is configurable at least in part, based on receipt of user input comprising the user standing at the threshold distance.

8. The device of claim 1, wherein input from the camera and object recognition software is used at least in part to determine that the user is at least one of outside the threshold distance and at the threshold distance.

9. The device of claim 1, wherein camera is three-dimensional (3D) camera, and wherein the determination is made at least in part based on input from the 3D carriers.

10. The device of claim 1, comprising a proximity sensor, wherein the determination is made at least in part based on input from the proximity sensor.

11. The device of claim 1, wherein the instructions are executable to:
disallow the camera from generating images based on light from exterior to the device in response to a determination that no motion has been detected for a threshold amount of time at least in part using images from the camera.

12. The device of claim 1, wherein the instructions are executable to:
in response to receipt of user input, disallow the camera from generating images based on light from exterior to the device.

13. The device of claim 1, wherein the instructions are executable to:
in response to receipt of user input, allow the camera to gather images based on light from exterior to the device regardless of identification of a distance of the user to the device.

14. The device of claim 13, wherein the instructions are executable to:
in response to receipt of the user input, allow light to pass from exterior to the device to the camera for a threshold time regardless of identification of the distance; and
in response to lapse of the threshold time, determine whether the user is at least one of outside the threshold distance and at the threshold distance.

15. The device of claim 1, wherein the instructions are executable to:
responsive to the determination, disallow light from passing from exterior to the device to the camera, wherein light is disallowed light from passing from exterior to the device to the camera at least in part based on actuation of at least one element on the device to render at least a portion of the device opaque.

16. A method, comprising:
determining that no person is proximate to a device; and
at least in response to determining that no person is proximate to the device, operating the device to limit light from passing from outside the device to a camera on the device.

17. The method of claim 15, wherein proximate is at least within a threshold distance to the device.

18. The method of claim 15, wherein the method comprises:
at least in part based on determining that at least one person is proximate to the device, operating the device to permit light to pass from outside the device to the camera.

19. The method of claim 15, wherein the device is operated to limit light from passing from outside the device to the camera at least in part based on operation of at least one of the group consisting of: switchable material on the device, a cover on the device.

20. A computer readable storage medium that is not a transitory signal, the computer readable storage medium comprising instructions executable by a processor to:
in response to a determination that a person is not within a threshold distance of a device, prevent a camera on the device from generating images based on light from exterior to the device.

21. The computer readable storage medium of claim 20, wherein the camera is prevented from generating images based on light from exterior to the device based at least in part on prevention of light from passing from outside the device to the camera, and wherein light is prevented from passing from outside the device to the camera at least in part based on operation of at least one of the group consisting of: electrically-switchable material on the device, mechanically-switchable material on the device, a cover on the device.
